(19) United States
(12) Patent Application Publication
(10) Pub. No.: US 2016/0019626 A1
(43) Pub. Date: Jan. 21, 2016

(54) Clothing Fitting System

(71) Applicant: Thanh Pham, Rowland Heights, CA (US)

(72) Inventor: Thanh Pham, Rowland Heights, CA (US)

(21) Appl. No.: 14/479,622

(22) Filed: Sep. 8, 2014

Related U.S. Application Data
(60) Provisional application No. 62/027,038, filed on Jul. 21, 2014.

(51) Int. Cl. G06Q 30/06

(52) U.S. Cl. CPC G06Q 30/0631

(57) ABSTRACT

A system and methods for predicting customer returns of purchased merchandise and offering suggestions to the customer for clothing size during the purchase process is described. The system makes use of data collection and historic purchase and return data to predict future purchase and return and makes suggestion to the customer to minimize customer returns, minimize cost of returns and maximize customer satisfaction.

### CROSS-REFERENCE TO RELATED APPLICATIONS

This application claims priority to U.S. Provisional application 62/027038 titled Clothing Fitting System, filed Jul. 21, 2014 with the same inventor and currently pending.

### BACKGROUND OF THE INVENTION

1. Technical Field

The present invention relates to a system and methods to aid in the purchase of clothing through predicting the proper fit.

2. Related Background Art

Clothing is purchased through a wide variety of mechanisms. Many people purchase clothing at department stores and specialty retailers. Others purchase clothing through on-line retailers. Still others purchase custom made clothing through tailors. In all scenarios it is important for customer satisfaction that the clothing purchased is the correct size. In some cases the purchaser has a chance to try on the clothing for proper fit. But in many of the purchase situations the purchaser is remote from the clothing and is using their measurements to select the best size. In many countries, clothing is the most popular online purchase. Up to half of the clothes purchased online are returned. Many of the returns are due to poor fit. This results in reduced margins for the retailers and dissatisfied purchasers. There is evidence that the online market for clothing would increase significantly if the customers could be assured of a better fit.

The likelihood of a better fit, where the clothing is not available to try on such as in an online purchase, may be increased with more measurements of the purchaser's body. This approach has been used with many systems that use special clothing designed just for taking measurements (U.S. Pat. No. 5,680,314), electronic imaging or scanning of a person's body to measure dimensions (U.S. Pat. No. 8,359,247), combinations of scanning and databases to fill in missing measurement data (U.S. Pat. No. 7,623,938). Feedback from purchasers however is that they are reluctant to provide more measurement information. This is attributed to both a desire for privacy and to the fact that the reason they are purchasing online is to save time in the purchasing process. Measurements take time.

There are also manufacturing variations in clothing sizes. In many cases the size of clothing will vary from batch to batch and from one manufacturer to the next. A size 8 dress from one manufacturer is not always equivalent as that from another. Additionally clothing fit is not strictly a measurement issue. Different styles of clothing fit differently both from a comfort factor and from an aesthetic factor. Some clothing styles look and/or feel better when fit snugly while for other styles a looser fit will result in fewer returns. There is also a factor of preferences of the purchaser. Each person has their own preferences as to how clothing should fit. When it comes to returns there are also user behavioral issues. Some people are much more likely to return a purchased article than others.

There is data for literally millions of completed transactions for clothing purchasers with data of which of the transactions were returned and in many cases the reasons for the return. In many cases the data is an anonymous database for a large population of purchasers and in other cases the database is generated by purchasing behavior of a particular single purchaser. There is scant use of this data to improve the estimate of the best fit or recommended fit for a purchaser.

There is a need for a system that takes account of all of the above mentioned factors to predict the likelihood that a purchaser will return an article of clothing. There is a need for a system that makes use of the predicted likelihood of return to aid the purchaser in size and style selection *during the purchasing process to both maximize purchases and minimize returns.

### DISCLOSURE OF THE INVENTION

The present invention provides a system for data collection regarding the fit of purchased clothing and analysis to provide a recommendation for the best fit for a purchaser. In one embodiment the system uses purchase and return data from both the purchaser and others to provide a recommendation for best fit of clothing presented for sale. In another embodiment the system uses measurements provided by the potential purchaser along with historic purchasing and return data to provide a size recommendation for the individual purchaser. In another embodiment the system uses the same data to provide an estimate of the likelihood the customer will purchase goods as a function of the recommendation. In another embodiment the system provides an estimate of the likelihood that a purchaser will return purchased goods. In one embodiment the system uses multivariate data analysis to provide a predictive equation for the likelihood of a purchaser returning a purchased article of clothing. In another embodiment the system uses the predictive equations to minimize costs of returned merchandise for an online retailer.

### BRIEF DESCRIPTION OF THE DRAWINGS

FIG. 1 shows a stylized block diagram of features of one embodiment of the invention.

FIG. 2 shows probability density distributions for likelihood of return of merchandise of different sizes.

FIG. 3 shows a data collection form used to collect data regarding returned merchandise.

FIG. 4 shows distribution curves for purchased and returned merchandise as a function of a measured body dimension.

FIG. 5 shows distribution curves for purchased and returned merchandise and includes calculation of probability of purchase and return.

FIG. 6 shows a flow chart overview for an embodiment of the process.

FIG. 7 shows a flow chart for creating predictive equations in an embodiment of the invention.

FIG. 8 shows a block diagram of the system for practicing the invention.

### DETAILED DESCRIPTION

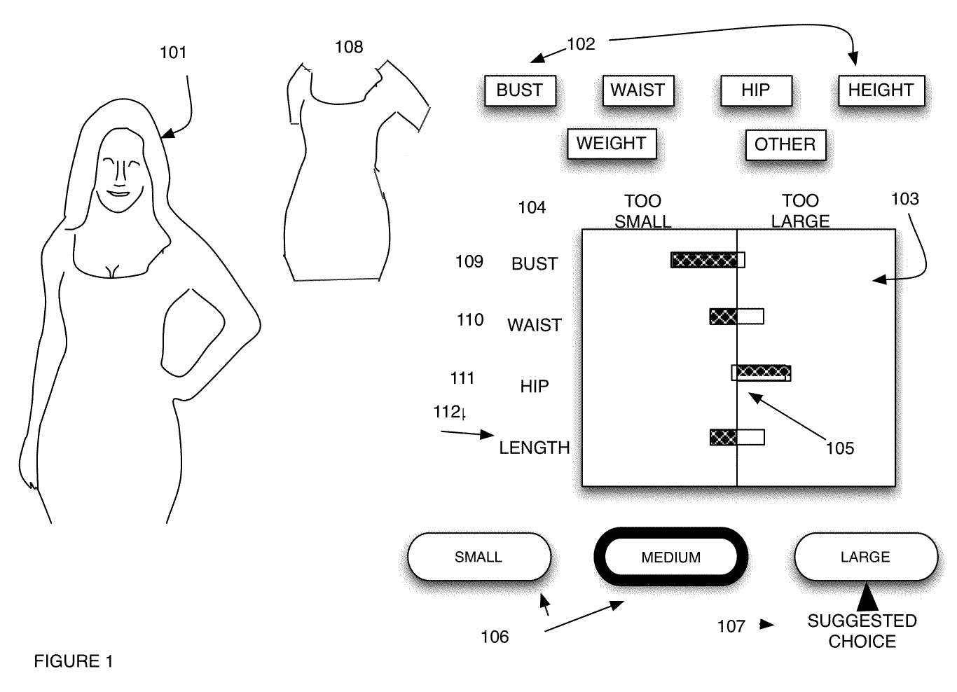

FIG. 1 depicts features of the system as may be viewed in some embodiments by either the purchaser of the goods, the seller of the goods or both. A purchaser 101 provides body measurements 102. Non-limiting example measurements include bust, waist, hip, height, weight and others such as inseam, shoe size, hat size all related to the particular merchandise 108 that the purchaser101 wishes to purchase. In another embodiment, not shown, the purchaser input of body measurements is in the form of a limited selection of sizes. In one embodiment the selection is small, medium and large. In another embodiment the purchaser input of body measurements is a selection of small, medium and large for each body dimension such as bust, waist, hip, etc. The purchaser selects a size 106. In this exemplary case the user has selected the Medium size for information. The system provides feed back information 103 regarding the opinion of the fit by other purchasers with similar body measurements 104 of the selected size 106 of the same merchandise. In one embodiment the feedback information is based upon satisfaction surveys of the purchasers. In another embodiment the feedback information is based upon return data for previously purchased merchandise. In one embodiment the feedback is based upon the identical merchandise. In another embodiment the feedback is based upon similar merchandise. Similar merchandise may be similar articles (in the exemplary case dresses) from the same manufacturer. In another embodiment similar merchandise may be selected from similar merchandise but from different manufacturers who have return rates that are the same within pre-selected limits. In another embodiment the similar merchandise is selected from similar merchandise (i.e. dresses, pants, hats, etc.) that have parameters in a parametric predicative equation of return that are within pre-selected limits. In the example shown a bar chart is provided indicating that for the particular selected size most other purchasers thought the bust size 109 was too small. The waist size 110 was equally divided amongst users as being too small and too large. The hip size 11 was too large in the opinion of most purchasers and the opinion on the length was equally divided amongst those who thought the size was too small or too large. In the exemplary case feedback of past purchasers is provided in the form of a bar chart 103. Where the size of the bars on either side of the dividing line is an indicator of the percentage of the population of previous purchasers who thought the fit for the particular body region was too small or too large. In other embodiments the feedback may be in the form of numeric counts of purchasers with the opinion regarding fit, numeric percentages, distribution charts and results of predicative equations of the probability of such an opinion given the particular size selected and the body measurement. The predicative equations being a multivariate fit of the independent variables of body measurements to the dependent variable of opinion regarding the fit. The size information 103 may be provided to the purchaser or the seller or both. In another embodiment the system further provides a suggested choice 107 to the purchaser. In one embodiment the suggested size is based upon a multivariate equation fit of the fit opinion data as an dependent variable upon the body measurement data as independent variables with the selected size selected such that the predicted distribution of opinions most nearly cluster around the central line. That is the predicted opinions would be most nearly equally divided between too small and too large. In one embodiment the opinions of too small and too large are scaled such that the percentage of opinions of too large would scale from 0 to 1 and the opinions for too small would scale 0 to −1 and the optimization is to find the selected size that would result in a scaled predicted opinion most nearly at zero.

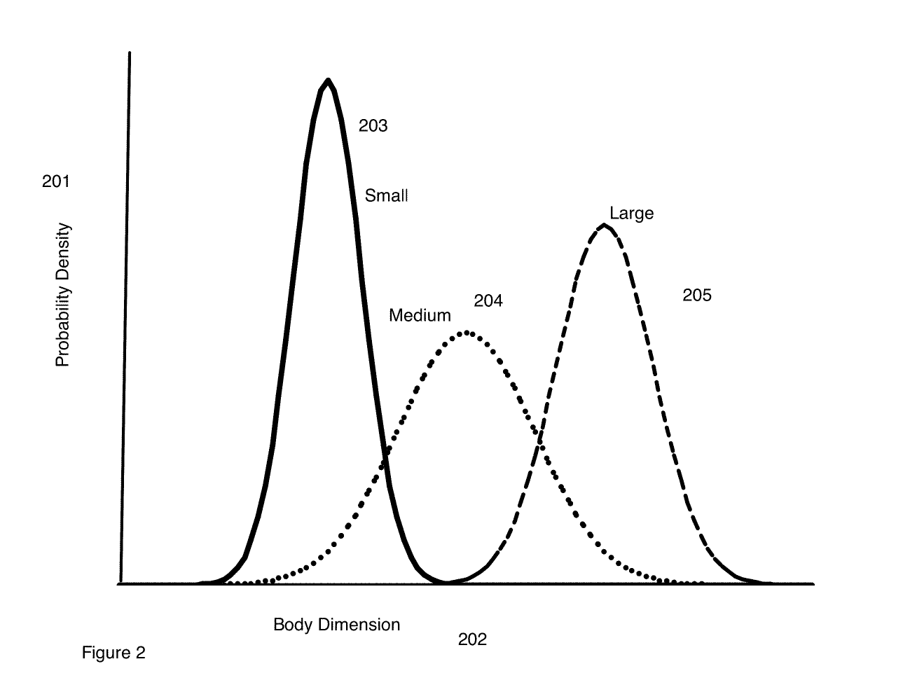

Referring now to FIG. 2, a step in the analysis of the data is shown. The Figure shows return data as probability density functions for articles of clothing that come in three different sizes small 203, medium 204 and large 205. The y axis 201 is the probability density and the x axis 202 is a body dimension. The curves represent the probability of return of the article of clothing due to misfit in the body dimension shown in the x-axis 202. The sizes are limited to three different sizes here and elsewhere in this document for exemplary purposes only. There may be fewer or greater number of sizes in practice of the invention. The body dimensions represents any body dimension that is measured and relevant to the fit of the article of clothing under consideration. The curves in this case represent the probability density for returns 201 as a function of the body dimension 202 for three different sizes of clothing. The area under each of the three curves is 1.0 representing the total probability for all sizes. The curves are generated by recording data for the number of returns as a function of the body dimensions from actual sale and return data. Sampling data for a number of returns provides an estimate for each curve. Although shown as gaussian, the actual data may result in a variety of curve shapes, but the principles are the same. The integrated area under the curve represents the probability the return came from persons with body dimensions as given by the x-axis values. The area under the curve between two points along the x-axis 202 represents the probability the return is from people with body dimensions between the two points.

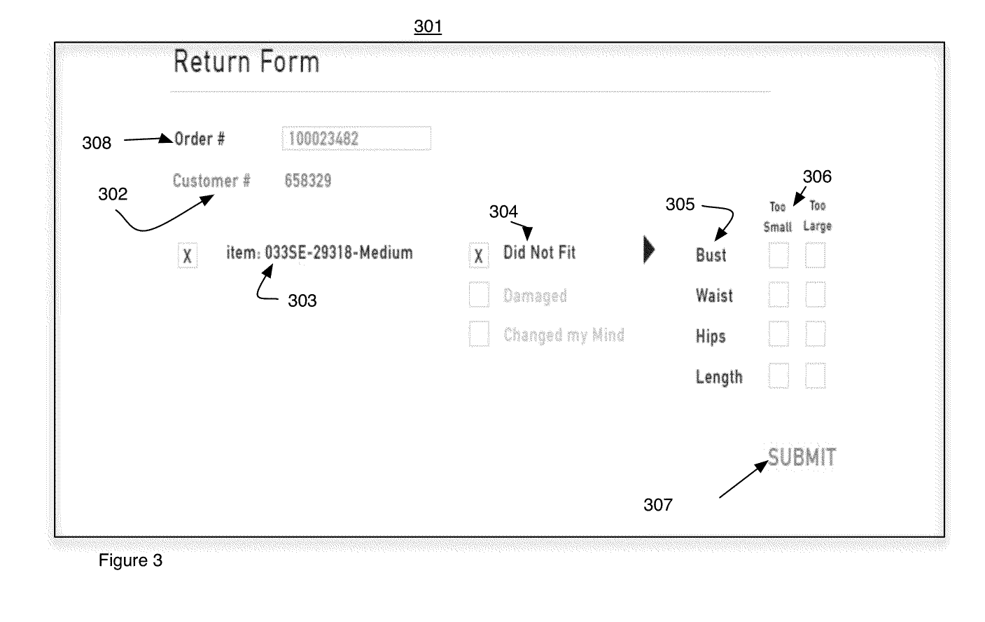

Referring to FIG. 3 a data collection embodiment for returned merchandise is shown. The return form 301 includes an order number 308 that allows connection of the return data to the original purchase data along with a customer identification 302. In some embodiments only one or the other of the order number and customer number are required. The return form further includes identification of the merchandise being returned 303 as well as a reason the merchandise is being returned 304 and if the reason is did not fit, as shown in the example, a selection of the body dimension 305 where the misfit occurred and whether the fit was too large or too small 306. In one embodiment the selection of neither too large nor too small is used as an indicator that the article of clothing fit OK in that particular body dimension. In one embodiment the form is submitted electronically through a web page or application running on a computing device and the form further includes a submit selector 307 that causes the information to be electronically submitted to the seller of the merchandise. In another embodiment the form is submitted as a paper copy and there is no submit selector for electronic submission.

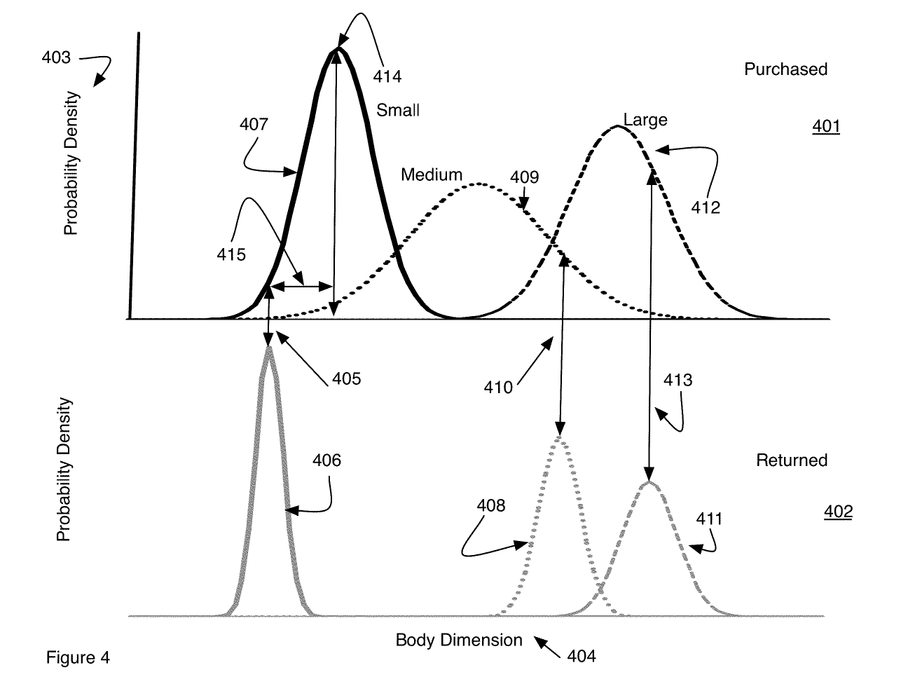

The purchase records of all articles of a particular merchandise purchased and the return data as collected as described above is used to create the data as shown in FIG. 4. Both charts 401, 402 are probability density functions as described in FIG. 2. The first curve 401 is a probability density function for the purchased merchandise. The second curve 402 is a probability density function for the returned merchandise. In one embodiment the “particular merchandise” refers to a particular identical merchandise. That is the same article from the same manufacturer and the same size. In another embodiment the data is collected for similar merchandise. Similar merchandise is as already discussed includes in one embodiment, the same article from the same manufacturer but from different lot numbers, in another embodiment the same category of goods i.e. dresses, or shoes or hats from all manufacturers. In another embodiment the similar merchandise is from the same category of goods selected such that the probability density curves for both sales and returns are the same within pre-selected limits. In one embodiment the pre-selected limits are determined as parameters that describe the curves having the same numeric value within pre-selected limits. As a non-limiting example if the data is found to Gaussian distribution curves by tests as are known in the art and the parameters for the Gaussian curves being a mean and a standard deviation then the articles are similar if they exhibit means and standard deviations for the data within pre-selected limits. As already discussed the data shown in the FIG. 4 exhibit Gaussian distributions, but other distributions, empirically determined, can be equivalently analyzed under the described embodiments. In one embodiment the probability density 403 of the y-axis are empirically determined from purchase data 401 and from return data 402, for each size value of the merchandise. In the example shown there are small 406, 407 medium 408, 409 and large 411, 412 size values. The data is plotted as a function of a body dimension 404. In a preferred embodiment the scale of the y-axis for the return merchandise is such that the data value shown in the curves 406, 408, 411 represent the fraction of the purchased merchandise 407, 409, 412 that has in fact been returned. That is the total area under the curve 406 divided by the total area under the curve 407 represents the fraction of the purchased merchandise sized small that is returned. It is seen in the example that mean values for the curves do not necessarily overlap. That is in the case of the small merchandise the mean value of the returned merchandise 405 is at the low end of the curve of the purchased merchandise and the mean values for the returned medium merchandise 410 and returned large sized merchandise 413 are in the larger body size regions of the curves for the merchandise purchased 409 and 412 respectively. In one embodiment the location of the mean is used to logically infer the reason for the return. Considering only the data for the small sized merchandise 406, 407 the data indicates that the returns for size misfit would be due to the merchandise returned because it is too large. This is seen because the distribution of body sizes for returns 406 fall at the low end of the curve for the purchased merchandise 407. If in fact the converse were true (that is the returns are because the merchandise is too small) it would be expected that purchasers with larger body dimensions would be returning the merchandise more frequently. The same analysis would infer that the medium 408, 409 and large sizes 411, 412 are being returned due to the merchandise being too small. The data collection and analysis as shown allows an inference as to whether the particular merchandise is running large or small against expectations for the purchasing populations. The recommendations for sizes can then be made accordingly. If a body size falls at the low end of the distribution of sizes for purchasers a size recommendation to the purchaser would be to purchase a product at the next lower size (a size smaller that small, not shown). Similarly if a persons body size measurement falls at the high end of the medium range 410 and is considering a medium size for purchase would be recommended to purchase the next larger size. The probability of a return for a particular body type is related to the difference 415 between the mean of body dimension measurement for the purchased merchandise (414 for the small size) and the mean of body dimension measurement for the returned sized 405. That is if the difference 415 is large the recommendation would be to select the nearest next size. If the difference is small then the considered size would be recommended. Where considered is the selected purchased size curve to which the comparison is made. The relative values for the difference 415 of large and small is relative to the breadth of the distributions of the purchased and returned probability density functions. Very broad distributions make it less likely to make a recommendation as to the cause of the returns is less definite as opposed to narrow distributions. In the example shown a recommendation for a size is more likely for those purchasing small size and having a small body dimension than it would be for a large size where the distribution is broader. In one embodiment the decision to make a recommendation regarding size is based upon historic data where size recommendations according to the logic discussed above are in fact made and a determination that returns are reduced. That is if over a period of time recommendations are made but returns do not decrease compared with a period of time when recommendations are not made then the future likelihood of making a size recommendation is reduced.

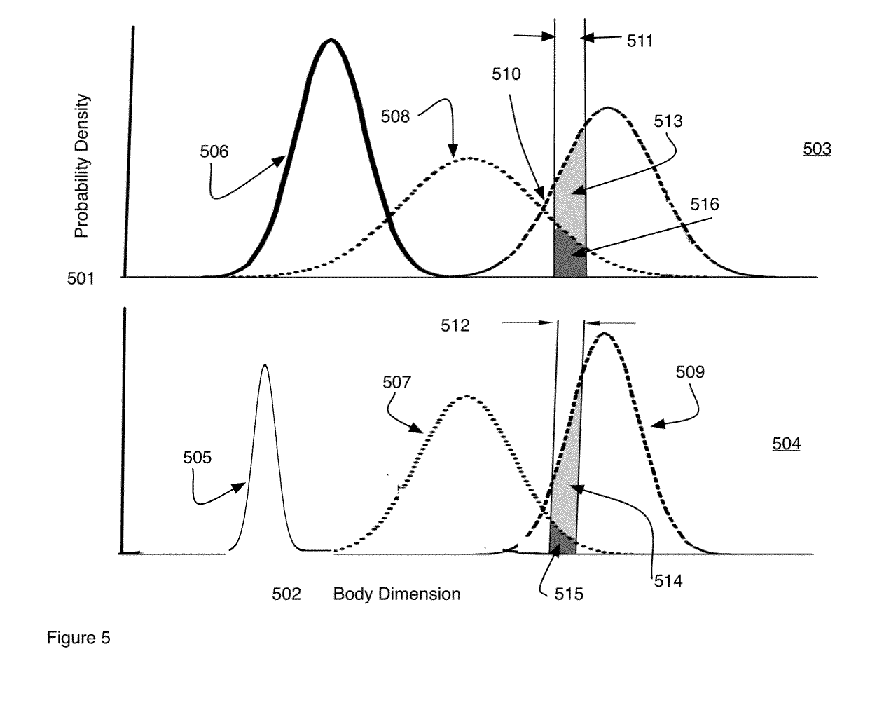

Referring now to FIG. 5, the method for calculating the probability of a return for a particular body dimension is shown. As before both charts 503, 504 are probability density graphs with the y-axis 501 representing a probability density and the x-axis 502 representing a body dimension. The top curves 503 represents the distributions for purchased products for three different sized merchandise: small 506, medium 508 and large 510. The lower curves 504 is for data from returns of the same merchandise in the same three sizes small 505, medium 507 and large 509. In one embodiment the curves are a best fit curve to the collected data for sold and returned merchandise. For the large size the area 514 divided by the area 513 multiplied by the total percentage of returned merchandise for the large size represents the estimated probability that purchasers with body size within the region 511 (512 on lower curve) will return large sized merchandise. For medium sized merchandise in the same region the probability are calculated the same using the regions 515 and 516. In one embodiment given the two calculated probabilities a recommendation for the purchaser with size within the regions 512 is to purchase that size with the lower probability of return.

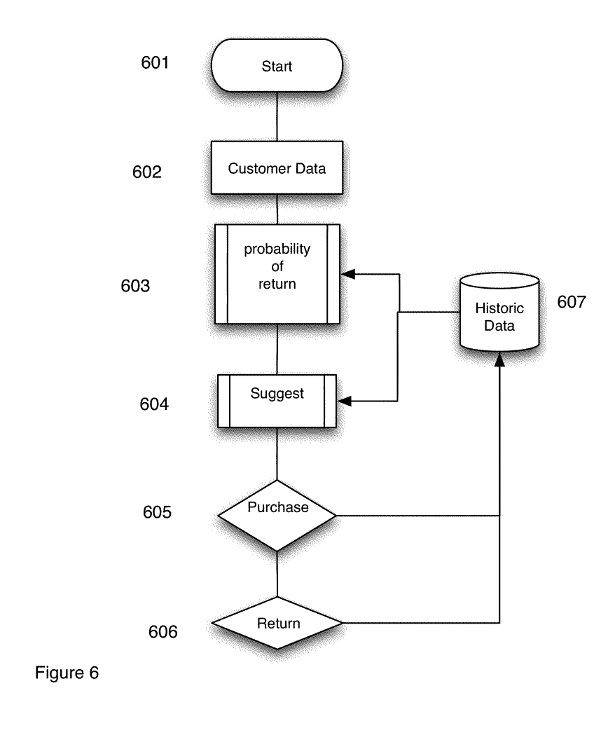

FIG. 6 shows a flow chart for an overall view of an embodiment of the invention. The process begins 601 with a customer shopping for clothing. The shopping may be done on line or in a clothing store. Customer size data is collected 602 and entered into a computing device. Nonlimiting customer size data includes body measurements such as height, weight, body circumference at multiple points around the purchaser for example bust or chest, waist and hips, inseam length size of circumference of customers head and so forth. The measurements are collectively known as body dimensions as described in the rest of this document. The Probability of a return is calculated 603 using historic data 607. The procedure in one embodiment is as described above in conjunction with FIGS. 1-5. In another embodiment the probability of return is calculated using a multi-variable predictive model described below. The probability of returned merchandise is then used to suggest 604 a size for the customer to purchase. In one embodiment the suggested size is selected that will minimize customer returns. In another embodiment the suggested size is selected to maximize profit. The process continues to a purchase decision step 605. Whether the customer purchases the merchandise or not is recorded in the database to be used in predictive models for future purchases and returns. If purchased the customer then decides 606 as to whether to keep or return the merchandise. Either decision is again recorded in the historic data database 607 to be used for future predictions of likelihood of purchase and return. The occurrence of “no return” must be defined since the customer may keep the merchandise for an undetermined period of time prior to return. In one embodiment no return means the merchandise is not returned within a pre-selected time after purchase. The process continues with updating the probability of return calculation 603 using the updated data of the latest purchase and return information.

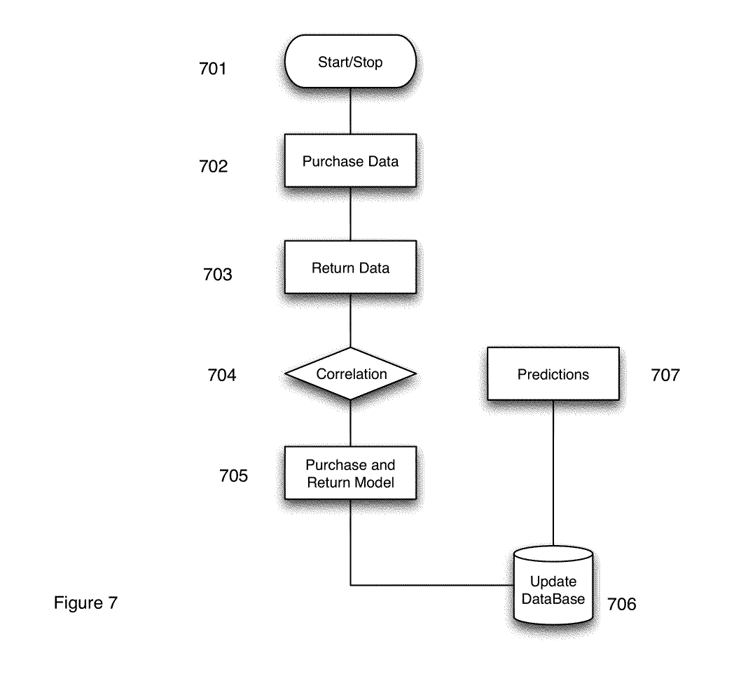

In another embodiment shown in FIG. 7 a multi-variate model for predicting returns is shown. The process starts 701 with shopping and a decision to make a purchase. The features are as already discussed, include a choice of sizes for the customer to purchase clothing, input of customer data and a suggested size to the customer. Customer purchase data 702 is collected followed by collection of return data 703. The customer purchase data includes the body dimensions of the customer, whether the customer made a purchase, whether a size recommendation was made, what the size recommendation was, historic data regarding the customer's past purchases, historic data regarding the customer's past returns, customer demographics including age, sex, income, and location. The customer purchase data is then tested for correlation 704 with purchase and return behavior and creation of a purchase and return model 705. In one embodiment the test for correlation 704 and predictive model 705 means performing a multiple variable linear regression where the dependent variables are the observed number of purchases and fraction of purchased goods that are returned and the independent variables are the customer purchase data. That is a mathematical model based upon historic data is created to calculate a likelihood that a purchase will be made given the input customer purchase data and the likelihood that if the purchase is made, the estimate of the return rate. In one embodiment the model is specific to a customer. In another embodiment the model is specific to a demographic of a customer. The database that includes models is updated 706 and the updated models are used in future predictions and customer purchase suggestions 707. The models 705 look for correlations with customer purchase data and purchase and return data. In one embodiment there is no requirement that the models are logically consistent. For example logically it would seem that a customer who has a certain body dimension and purchases clothing that is known not to fit that body dimension is more likely to return the merchandise. However in this embodiment the likelihood or fraction of return is calculated strictly on the basis of the numeric data and human nature may result in return behavior that is counter to the stated logic. In another embodiment the model is checked for logical consistency and if not consistent the independent variables for such terms are given less weight in a regression fit to the purchase and or return data. In one embodiment both likelihood of purchase as well as likelihood of return are calculated for a given suggested size scheme. It is possible that customers are less likely to make a purchase if a size suggestion is given. In another embodiment the likelihood of making a purchase includes demographic data. It is possible that some customer demographics are more or less likely to make a purchase given a suggested size. In one embodiment the predicted profit is calculated on the basis of the known cost and price information and the likelihood of a return and the cost of a return. In another embodiment the models are used to make size suggestions to optimize the predicted profit.

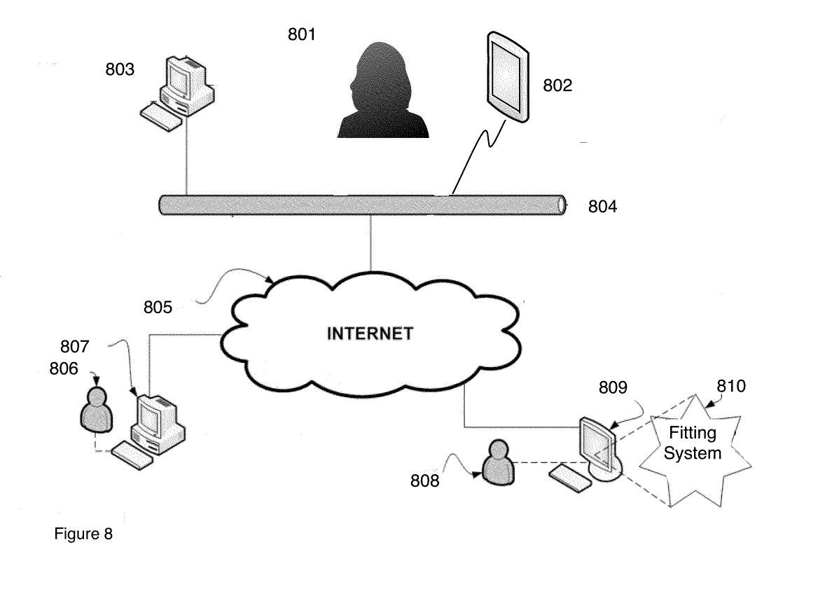

Referring now to FIG. 8 a system for practicing the invention is shown. A customer 801 has access to a computing device 802, 803 for inputting customer data including body dimensions, identification and demographic information. The Customer may be shopping on line and input the data from a home personal computer 803 or may input the information to a portable computing device 802. The devices are connected to a network 804 that is connected to the Internet 805. The network 804 may be a wired computer network or a cellular network. In another embodiment the customer input data may be collected by a salesperson 806 who inputs the data on a computing device 807 that is connected to the Internet 805 or other wise in electronic communication with a computing device 809 that is programmed to execute commands of the fitting system 810 to predict a likelihood of return and offer suggestions to the customer through their computing device 802, 803. The computing system further includes storage for the database of historic purchase and return data and a database of model parameters that are updated as new purchase and return data is obtained. In another embodiment the size suggestions and other model output is provided to a sales person 806 who relays the information to the customer. One embodiment further includes an operator 808 for the computing system that includes the database and models 809. In another embodiment the system is completely automated and no sales people 806 or operators 808 are required. In another embodiment all of the input and modeling and storage of the database and model parameters are done on a single computing device. Interconnections between computing devices may be through local are networks, local area networks and the internet and wired or wireless local of global networks such as device interacting through local wireless communication protocols or global cellular networks.

### SUMMARY

A system and methods for predicting customer returns of purchased merchandise and offering suggestions to the customer for clothing size during the purchase process is described. The system makes use of data collection and historic purchase and return data to predict future purchase and return and makes suggestion to the customer to minimize customer returns, minimize cost of returns and maximize customer satisfaction and profit. The present invention has been described in terms of the preferred embodiment and it is recognized that equivalents, alternatives and modifications, beyond those expressly stated, are possible and are within the scope of the attached claims.

What is claimed is:

1. A clothing fitting system comprising.
a. a computing device programmed to accept as input a plurality of body dimensions of a customer and feedback from the customer, feedback including whether a previously purchased clothing item having a labeled size fit too tightly or fit too loosely in each of the plurality of body dimensions,
b. the computing device further programmed to predict the fit of a selected article of clothing having a labeled size, using as input variables the plurality of the customer's body dimensions, the feedback from the customer of the previously purchased clothing fit, the labeled size of the previously purchased clothing item and the labeled size of the selected article of clothing.

2. The clothing fitting system of claim 1 wherein the plurality of body dimensions is input as numerical values.

3. The clothing fitting system of claim 1 wherein the plurality of body dimensions is input as a selection of one of small, medium and large.

4. The clothing fitting system of claim 1 wherein the programmed to predict the fit of a selected article of clothing includes calculating the probability that the article of clothing will fit.

5. The clothing fitting system of claim 4 wherein the probability that the selected article will fit is calculated using a multiple variable predictive model created using as input variables the plurality of body dimensions and the feedback and having an output variable of the probability that the article of clothing will fit.

6. The clothing fitting system of claim 4 wherein the probability that the selected article will fit is calculated using an observed distribution curve of the probability of fit for each of the body dimensions and calculating the area under the distribution curve that overlap with the labeled size of the selected article, whereby the probability of fit of the selected article is proportional to the calculated area.

7. A clothing fitting system comprising.
a. a computing device programmed to accept as input a plurality of body dimensions of a plurality of prior purchasers of a clothing item having a labeled size and feedback from the plurality of prior purchasers of the clothing item fit too tightly or fit too loosely in each of the plurality of body dimensions,
b. the computing device further programmed to predict the fit of a selected article of clothing having a labeled size on a customer, said customer having a plurality of body dimensions, using as input variables the plurality of body dimensions of a plurality of prior purchasers, the feedback from the plurality of prior purchasers of the clothing item fit, the labeled size of the previously purchased clothing item and the labeled size of the selected article of clothing and the plurality of body dimensions of the customer.

8. The clothing fitting system of claim 7 wherein the plurality of body dimensions of a plurality of prior purchasers is input as numerical values.

9. The clothing fitting system of claim 7 wherein the plurality of body dimensions of a plurality of prior purchasers is input as a selection of one of small, medium and large.

10. The clothing fitting system of claim 7 wherein the programmed to predict the fit of a selected article of clothing includes calculating the probability that the article of clothing will fit.

11. The clothing fitting system of claim 11 wherein the probability that the selected article will fit is calculated using a multiple variable predictive model created using as input variables the plurality of the customer's body dimensions, the feedback from the plurality of prior purchasers of the clothing item fit, the labeled size of the previously purchased clothing item and the labeled size of the selected article of clothing and the plurality of body dimensions of the customer and having an output variable of the probability that the article of clothing will fit the customer.

12. The clothing fitting system of claim 11 wherein the probability that the selected article will fit is calculated using an observed distribution curve of the probability of fit for each of the plurality of body dimensions of a plurality of prior purchasers and calculating the area under the distribution curve that overlap with the plurality of body dimensions of the customer, whereby the probability of fit of the selected article is proportional to the calculated area.
